(19) United States
(12) Patent Application Publication
(10) Pub. No.: US 2026/0279680 A1
(43) Pub. Date: Sep. 17, 2026

(54) MULTILAYER CERAMIC CAPACITOR

(71) Applicant: Murata Manufacturing Co., Ltd., Nagaokakyo-shi (JP)

(72) Inventors: Ryuya KOBAYASHI, Nagaokakyo-shi (JP); Yuu MIKAMI, Nagaokakyo-shi (JP)

(21) Appl. No.: 19/533,879

(22) Filed: Feb. 9, 2026

(30) Foreign Application Priority Data
Mar. 14, 2025 (JP) 2025-041602

(51) Int. Cl. H01G 4/30; H01G 4/012; H01G 4/232

(52) U.S. Cl. CPC H01G 4/30; H01G 4/012; H01G 4/2325

(57) ABSTRACT

A multilayer ceramic capacitor includes a multilayer body including dielectric layers, inner electrodes on the dielectric layers, first and second surfaces facing in a stacking direction, third and fourth surfaces facing in a first direction, and fifth and sixth surfaces facing in a second direction, and first and second outer electrodes respectively on the third and fourth surfaces. The inner electrodes include Cu, and the dielectric layers include at least one of Ca, Sr, Zr, or Ti. The inner electrode closest to the first surface is, at an end portion on a side that is not connected to the first outer electrode or the second outer electrode, curved toward the second surface, and the inner electrode closest to the second surface is, at an end portion on a side that is not connected to the first outer electrode or the second outer electrode, curved toward the first surface.

### CROSS REFERENCE TO RELATED APPLICATIONS

This application claims the benefit of priority to Japanese Patent Application No. 2025-041602 filed on Mar. 14, 2025. The entire contents of this application are hereby incorporated herein by reference.

### BACKGROUND OF THE INVENTION

### 1. Field of the Invention

The invention relates to multilayer ceramic capacitors.

### 2. Description of the Related Art

There is a demand for capacitors used in, for example, high-frequency matching uses to have low ESR (Equivalent Series Resistance) and high SRF (Self-Resonant Frequency), and one way of meeting this demand is to use a multilayer ceramic capacitor having an LW reverse structure.

At the same time, there is a demand for capacitors used in, for example, high-frequency matching uses to be smaller-deviation capacitors having small deviations or variations in electrostatic capacitance.

However, in a multilayer ceramic capacitor having an LW reverse structure such as that described in Japanese Unexamined Patent Application Publication No. 2006-173270, the distance between an inner electrode of an outermost layer and a wraparound electrode of a facing outer electrode is small, and thus the multilayer ceramic capacitor is affected by stray capacitance resulting from the small distance. The stray capacitance causes a problem in that deviations or variations in the electrostatic capacitance of the multilayer ceramic capacitor become large.

### SUMMARY OF THE INVENTION

Example embodiments of the present invention provide multilayer ceramic capacitors each having an LW reverse structure and used in, for example, high-frequency matching uses, and each being unlikely to be adversely affected by stray capacitance and able to reduce or prevent deviations or variations in electrostatic capacitance.

A multilayer ceramic capacitor according to an example embodiment of the present invention includes a multilayer body including a plurality of dielectric layers stacked on each other, a plurality of inner electrodes on the plurality of dielectric layers, a first surface and a second surface facing each other in a stacking direction, a third surface and a fourth surface facing each other in a first direction orthogonal or substantially orthogonal to the stacking direction, and a fifth surface and a sixth surface facing each other in a second direction orthogonal or substantially orthogonal to the stacking direction and the first direction, a first outer electrode on the third surface of the multilayer body, and a second outer electrode on the fourth surface of the multilayer body. When a dimension of the multilayer body in the first direction is 1 and a dimension of the multilayer body in the second direction is w, w>1. The plurality of inner electrodes include first inner electrodes on the plurality of dielectric layers, exposed at the third surface, and connected to the first outer electrode, and second inner electrodes on the plurality of dielectric layers, exposed at the fourth surface, and connected to the second outer electrode. The plurality of inner electrodes include, as a main component, Cu. The plurality of dielectric layers include, as a main component, a dielectric material including at least one of Ca, Sr, Zr, or Ti. Of the first inner electrodes or the second inner electrodes, the inner electrode closest to the first surface is, at an end portion on a side that is not connected to the first outer electrode or the second outer electrode, curved toward the second surface. Of the first inner electrodes or the second inner electrodes, the inner electrode closest to the second surface is, at an end portion on a side that is not connected to the first outer electrode or the second outer electrode, curved toward the first surface.

In a multilayer ceramic capacitor according to an example embodiment of the present invention, of the first inner electrodes or the second inner electrodes, the inner electrode closest to the first surface is, at the end portion on the side that is not connected to the first outer electrode or the second outer electrode, curved toward the second surface, and, of the first inner electrodes or the second inner electrodes, the inner electrode closest to the second surface is, at the end portion on the side that is not connected to the first outer electrode or the second outer electrode, curved toward the first surface. Therefore, since the end portion of each outermost inner electrode is curved inward in the stacking direction, it is possible to reduce stray capacitance that is generated between the inner electrodes and the wraparound electrodes of the outer electrodes, and to reduce or prevent deviations or variations in electrostatic capacitance. In addition, it is possible to increase adhesion strength between the inner electrodes and the dielectric layers, and to reduce or prevent an occurrence of defects in an internal structure of the multilayer body.

According to example embodiments of the present invention, multilayer ceramic capacitors each having an LW reverse structure and used in, for example, high-frequency matching uses, and each being unlikely to be affected by stray capacitance and able to reduce or prevent deviations or variations in electrostatic capacitance, are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view showing an example of a multilayer ceramic capacitor according to an example embodiment of the present invention.

FIG. 2 is a cross-sectional view along line II-II of FIG. 1.

FIG. 3 is a cross-sectional view along line III-III of FIG. 1.

FIG. 4 is a cross-sectional view along line IV-IV of FIG. 1.

FIG. 5 is a cross-sectional view along line V-V of FIG. 1.

### DETAILED DESCRIPTION OF THE EXAMPLE EMBODIMENTS

Example embodiments of the present invention will be described in detail below with reference to the drawings.

A multilayer ceramic capacitor according to an example embodiment of the present invention is described below.

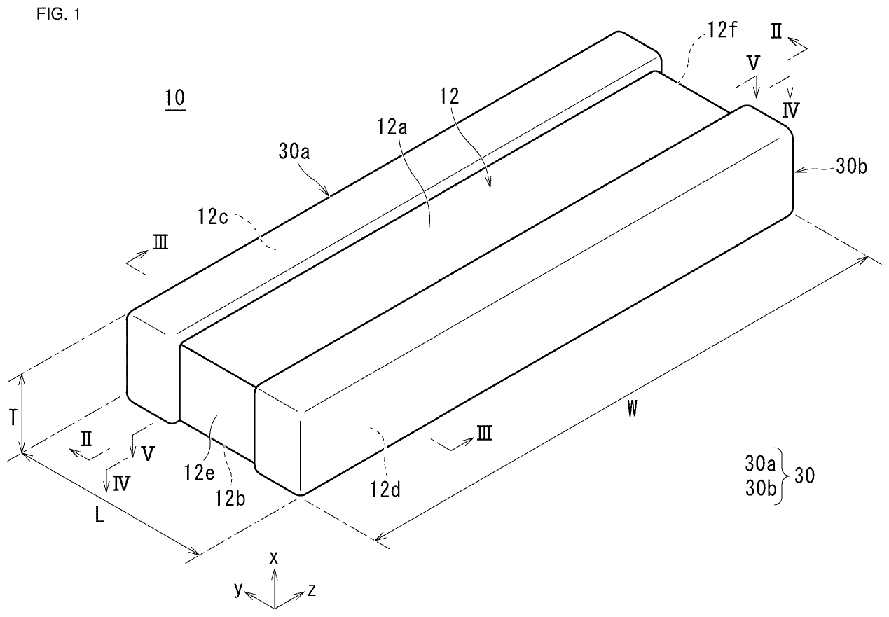

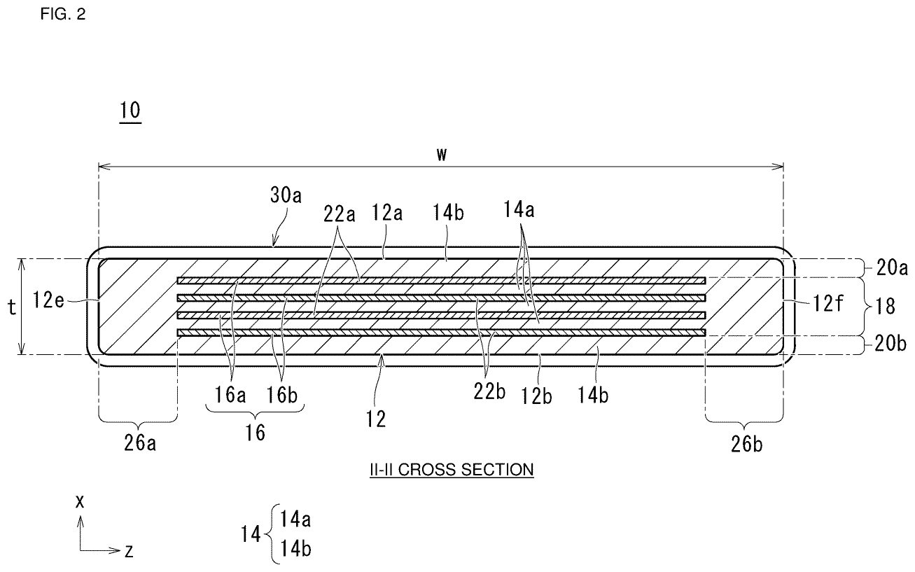

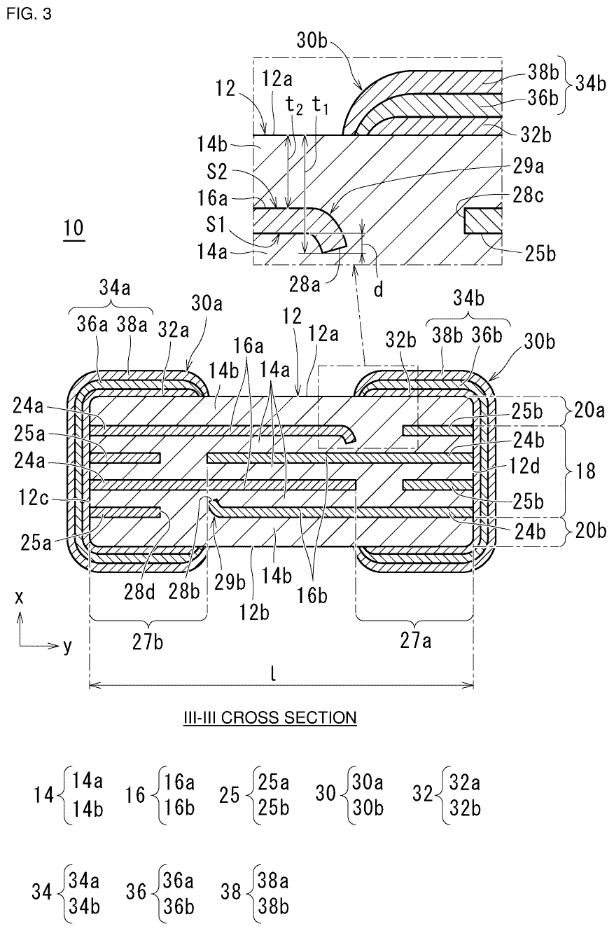

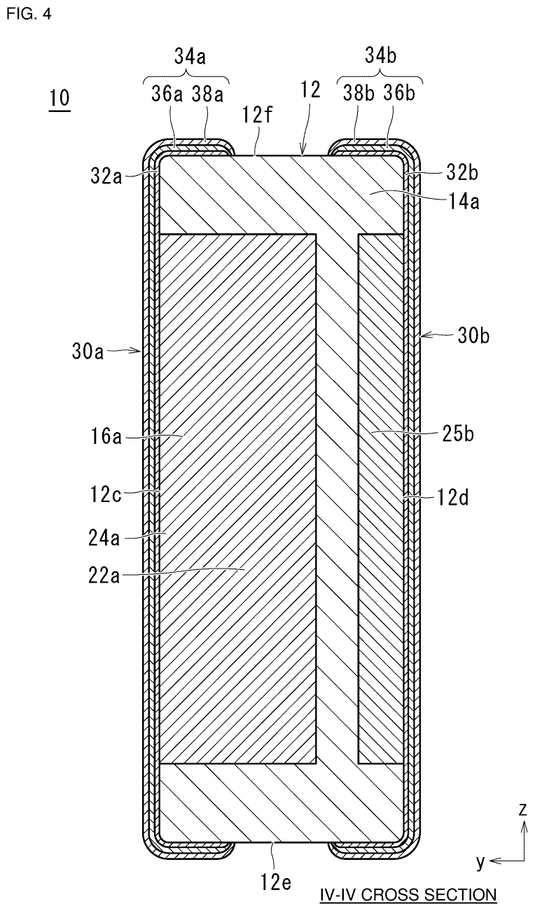

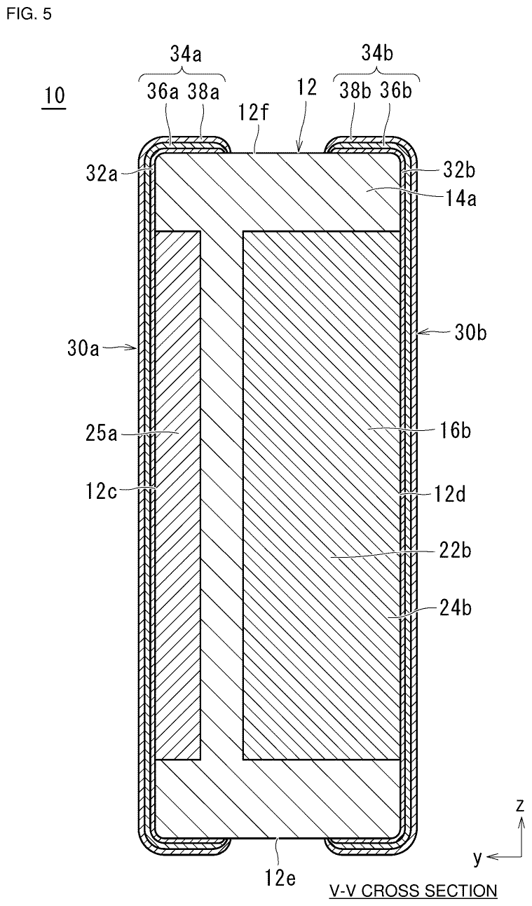

FIG. 1 is an external perspective view showing an example of a multilayer ceramic capacitor according to an example embodiment of the present invention. FIG. 2 is a cross-sectional view along II-II of FIG. 1. FIG. 3 is a cross-sectional view along line III-III of FIG. 1. FIG. 4 is a cross-sectional view along line IV-IV of FIG. 1. FIG. 5 is a cross-sectional view along line V-V of FIG. 1.

As shown in FIG. 1, a multilayer ceramic capacitor 10 includes a rectangular or substantially rectangular parallelepiped multilayer body 12 and outer electrodes 30 that are disposed on a corresponding one of two end portions of the multilayer body 12.

The multilayer body 12 includes a plurality of dielectric layers 14 that are stacked on each other, and a plurality of inner electrodes 16 that are provided on the dielectric layers 14. Further, the multilayer body 12 includes a first surface 12a and a second surface 12b that face each other in a stacking direction x, a third surface 12c and a fourth surface 12d that face each other in a first direction y orthogonal or substantially orthogonal to the stacking direction x, and a fifth surface 12e and a sixth surface 12f that face each other in a second direction z orthogonal or substantially orthogonal to the stacking direction x and the first direction y.

It is preferable that the first surface 12a and the second surface 12b or one of the surfaces are flat. When the surface or surfaces are flat, stress that is received from a nozzle that picks up the multilayer ceramic capacitor 10 can be dispersed by the flat surface or flat surfaces. As a result, when the multilayer ceramic capacitor is being mounted, the strength of the multilayer ceramic capacitor can be increased.

The surfaces of the multilayer body 12 may be rough.

The multilayer body 12 may be rounded at its corners and ridges.

Portions where any two of the first surface 12a, the second surface 12b, the third surface 12c, the fourth surface 12d, the fifth surface 12e, and the sixth surface 12f meet are called ridges, and portions where any three of them meet are called corners. It is preferable that the ridges and the corners are rounded. When the ridges and the corners are rounded, it is possible to prevent cracking. When the ridges and the corners are rounded, main surfaces excluding the ridges and the corners may be flat.

Here, a dimension of the multilayer body 12 in the first direction y is an 1 dimension, a dimension of the multilayer body 12 in the second direction z is a w dimension, and a dimension of the multilayer body 12 in the stacking direction x is a t dimension. The dimension 1 of the multilayer body 12 in the first direction y is smaller than the dimension w of the multilayer body 12 in the second direction z. Therefore, since an electrical current path can be made shorter, it is possible to reduce the ESL of the multilayer ceramic capacitor 10.

As shown in FIGS. 2 and 3, in the stacking direction x in which the first surface 12a and the second surface 12b are connected to each other, the multilayer body 12 includes an inner layer portion 18 including the dielectric layers 14 and the inner electrodes 16 that are alternately stacked on each other, a first-surface-side outer layer portion 20a including the dielectric layers 14 that are positioned between the first surface 12a and the inner electrode 16 that is positioned on a side closest to the first surface 12a, and a second-surface-side outer layer portion 20b including the dielectric layers 14 that are positioned between the second surface 12b and the inner electrode 16 that is positioned on a side closest to the second surface 12.

The inner layer portion 18 includes, of the plurality of dielectric layers 14, a plurality of inner-layer dielectric layers 14a. That is, the inner layer portion 18 is configured such that the plurality of inner electrodes 16 face each other with the inner-layer dielectric layers 14a interposed therebetween.

The inner-layer dielectric layers 14a include, as a main component, at least a ceramic material including, as a main component, at least one of Ca, Sr, Zr, or Ti, for example. Specifically, for example, a ceramic material having a perovskite structure represented by a general formula ABO₃ including Ca and Zr is a main component. Examples of such a ceramic material having a perovskite structure include CaZrO₃ (calcium zirconate) or TiO₂ (titanium oxide), but are not limited thereto. Main components of the ceramic material of which each dielectric layer 14 is made may include at least one of Ca, Zr, or Ti. For CaZrO₃, for example, Ca(Zr_{0.9}Ti_{0.1})O₃ in which a portion of ZrO₃ or a portion of Zr is substituted by Ti may be used.

In accordance with the purpose, an additive is added to the ceramic material from which each dielectric layer 14 is made. Examples of such an additive include Mn, Mg, Dy, or Cr, or oxides of rare-earth elements such as V, Sm, Eu, Gd, Tb, Ho, Er, Tm, Yb, or Y, or oxides of Co, Ni, Li, B, Na, K, or Si, or glass.

The thickness of each dielectric layer 14 can be observed by measuring the distance between two inner electrodes that are adjacent to each other, that is, a first inner electrode 16a and a second inner electrode 16b. The thickness of each dielectric layer 14 is, for example, greater than or equal to about 1 μm and less than or equal to about 100 μm.

As shown in FIGS. 2 and 3, the inner electrodes 16 include first inner electrodes 16a and second inner electrodes 16b. The first inner electrodes 16a and the second inner electrodes 16b are alternately stacked on with each other with the inner-layer dielectric layers 14a being interposed therebetween.

The first inner electrodes 16a are disposed on the dielectric layers 14, and are positioned at an inner portion of the multilayer body 12. Each first inner electrode 16a includes a first facing electrode portion 22a that faces the second inner electrode 16b corresponding thereto, and a first extended electrode portion 24a that is positioned on one end side of the first inner electrode 16a and that extends from the first facing electrode portion 22a corresponding thereto to the third surface 12c of the multilayer body 12. An end portion of each first extended electrode portion 24a extends from the third surface 12c, and is exposed from the multilayer body 12. That is, the end portion of each first extended electrode portion 24a is not exposed at the first surface 12a and the second surface 12b, the fourth surface 12d, and the fifth surface 12e and the sixth surface 12f.

The shape of the first facing electrode portion 22a of each first inner electrode 16a is not particularly limited, but is preferably a rectangular or substantially rectangular shape in plan view. Moreover, corners in plan view may be rounded, or portions of the corners may be obliquely provided in plan view (may be tapered). Alternatively, the shape may be a tapering shape in plan view that is inclined toward either direction.

The shape of the first extended electrode portion 24a of each first inner electrode 16a is not particularly limited, but is preferably a rectangular or substantially rectangular shape in plan view. Moreover, corners in plan view may be rounded, or portions of the corners may be obliquely provided in plan view (may be tapered). Alternatively, the shape may be a tapering shape in plan view that is inclined toward either direction.

The width of the first facing electrode portion 22a of each first inner electrode 16a may be the same or substantially the same as the width of the first extended electrode portion 24a of each first inner electrode 16a, or either one of the widths may be narrower.

The second inner electrodes 16b are disposed on the dielectric layers 14 and are positioned at an inner portion of the multilayer body 12. Each second inner electrode 16b includes a second facing electrode portion 22b that faces the first inner electrode 16a corresponding thereto, and a second extended electrode portion 24b that is positioned on one end side of the second inner electrode 16b and that extends from the second facing electrode portion 22b corresponding thereto to the fourth surface 12d of the multilayer body 12. An end portion of each second extended electrode portion 24b extends from the fourth surface 12d, and is exposed from the multilayer body 12. That is, the end portion of each second extended electrode portion 24b is not exposed at the first surface 12a and the second surface 12b, the third surface 12c, and the fifth surface 12e, and the sixth surface 12f.

The shape of the second facing electrode portion 22b of each second inner electrode 16b is not particularly limited, but is preferably a rectangular or substantially rectangular shape in plan view. Moreover, corners in plan view may be rounded, or portions of the corners may be obliquely provided in plan view (may be tapered). Alternatively, the shape may be a tapering shape in plan view that is inclined toward either direction.

The shape of the second extended electrode portion 24b of each second inner electrode 16b is not particularly limited, but is preferably a rectangular or substantially rectangular shape in plan view. Moreover, corners in plan view may be rounded, or portions of the corners may be obliquely provided in plan view (may be tapered). Alternatively, the shape may be a tapering shape in plan view that is inclined toward either direction.

The width of the second facing electrode portion 22b of each second inner electrode 16b may be the same or substantially the same as the width of the second extended electrode portion 24b of each second inner electrode 16b, or either one of the widths may be narrower.

As shown in FIG. 2, the multilayer body 12 includes a side portion 26a of the multilayer body 12 that is provided between the fifth surface 12e and one end of each first facing electrode portion 22a in the second direction z and one end of each second facing electrode portion 22b in the second direction z, and a side portion 26b of the multilayer body 12 that is provided between the sixth surface 12f and the other end of each first facing electrode portion 22a in the second direction z and the other end of each second facing electrode portion 22b in the second direction z.

As shown in FIG. 3, the multilayer body 12 includes an end portion 27a of the multilayer body 12 that is formed between the fourth surface 12d and an end portion of each first inner electrode 16a on a side opposite to the first extended electrode portion 24a corresponding thereto, and an end portion 27b of the multilayer body 12 that is provided between the third surface 12c and an end portion of each second inner electrode 16b on a side opposite to the second extended electrode portion 24b corresponding thereto.

The inner electrodes 16 include, for example, Cu as a main component. This makes it possible to reduce the electrical resistance of each inner electrode 16 and to reduce ESR. In addition, when a main component of each inner electrode 16 is Cu, it is possible to make each inner electrode 16 with an inexpensive material.

The thickness of each inner electrode 16 is preferably, for example, greater than or equal to about 0.5 μm and less than or equal to about 3.0 μm. The thickness of each inner electrode 16 is more preferably, for example, greater than or equal to about 1.2 μm and less than or equal to about 2.4 μm. This is because, when the thickness dimension of each inner electrode 16 is less than about 1.2 μm, a Q value is reduced. In addition, this is because, when the thickness dimension of each inner electrode 16 is greater than about 2.4 μm, due to a difference between the compression of each inner electrode 16 and the compression of each dielectric layer 14, an interface between each inner electrode 16 and each dielectric layer 14 may be peeled.

The sum of the number of first inner electrodes 16a and the number of second inner electrodes 16b is preferably, for example, greater than or equal to four and less than or equal to 100.

Auxiliary electrodes 25 are disposed in the end portions 27a and 27b of the multilayer body 12. Specifically, first auxiliary electrodes 25a are disposed in the end portion (an L gap) 27b of the multilayer body 12 so as to be exposed at the third surface 12c. In addition, second auxiliary electrodes 25b are disposed in the end portion (an L gap) 27a of the multilayer body 12 so as to be exposed at the fourth surface 12d.

It is preferable that the first auxiliary electrodes 25a is disposed in the same plane as the second inner electrodes 16b and that the thickness of each first auxiliary electrode 25a is equal or substantially equal to the thickness of each second inner electrode 16b.

It is preferable that the second auxiliary electrodes 25b is disposed in the same plane as the first inner electrodes 16a and that the thickness of each second auxiliary electrode 25b is equal or substantially equal to the thickness of each first inner electrode 16a.

In this way, when the first auxiliary electrodes 25a and the second auxiliary electrodes 25b are provided, it is possible to reduce differences in levels at the L gap portions.

The first auxiliary electrodes 25a and the second auxiliary electrodes 25b may be disposed at the first-surface-side outer layer portion 20a and the second-surface-side outer layer portion 20b. In this case, it is preferable that the first auxiliary electrodes 25a and the second auxiliary electrodes 25b is disposed at portions corresponding to locations reached by moving the end portions (the L gaps) 27a and 27b of the multilayer body 12 parallel or substantially parallel to the stacking direction x. By providing the auxiliary electrodes in this way, when a plating layer is to be provided without providing underlying electrode layers 32, it becomes easier to form the plating layer.

When the first auxiliary electrodes 25a are to be provided in the same plane as the second inner electrodes 16b, and when the second inner electrodes 16b are to be printed, as a result of printing the first auxiliary electrodes 25a together with the second inner electrodes 16b, the first auxiliary electrodes 25a and the second inner electrodes 16b can be provided in the same plane.

When the second auxiliary electrodes 25b are to be provided in the same plane as the first inner electrodes 16a, and when the first inner electrodes 16a are to be printed, the second auxiliary electrodes 25b can be printed together with the first inner electrodes 16a.

At an inner portion of the multilayer body 12, the first auxiliary electrodes 25a and the second auxiliary electrodes 25b need not be provided.

L end portions of outermost inner electrodes 16 are curved inward in the stacking direction x. Specifically, of the first inner electrodes 16a or the second inner electrodes 16b, the inner electrode 16 that is closest to the first surface 12a is, at an L end portion 28a on a side that is not connected to the first outer electrode 30a or the second outer electrode 30b, curved toward the second surface 12b. Of the first inner electrodes 16a or the second inner electrodes 16b, the inner electrode 16 that is closest to the second surface is, at an L end portion 28b on a side that is not connected to the first outer electrode 30a or the second outer electrode 30b, curved toward the first surface 12a.

In this way, when the L end portions of the outermost inner electrodes 16 are curved inward in the stacking direction x, it is possible to reduce stray capacitance that is generated between these inner electrodes 16 and wraparound electrodes of the outer electrodes 30, and to reduce or prevent deviations or variations in electrostatic capacitance. In addition, it is possible to increase adhesion strength between the inner electrodes 16 and the dielectric layers 14, and to reduce or prevent an occurrence of defects in the internal structure of the multilayer body 12.

It is preferable that only the L end portions of the outermost inner electrodes 16 is curved inward in the stacking direction x. Specifically, of the first inner electrodes 16a or the second inner electrodes 16b, the inner electrode 16 that is closest to the first surface 12a includes, at only the L end portion 28a on the side that is not connected to the first outer electrode 30a or the second outer electrode 30b, a curved portion 29a that is curved toward the second surface 12b. Of the first inner electrodes 16a or the second inner electrodes 16b, the inner electrode 16 that is closest to the second surface 12b includes, at only the L end portion 28b on the side that is not connected to the first outer electrode 30a or the second outer electrode 30b, a curved portion 29b that is curved toward the first surface 12a.

In this way, when only the L end portions of the outermost inner electrodes 16 are curved inward in the stacking direction x, it is possible to reduce stray capacitance that is generated between these inner electrodes 16 and the wraparound electrodes of the outer electrodes 30, and to reduce or prevent deviations or variations in electrostatic capacitance. In addition, it is possible to increase adhesion strength between the inner electrodes 16 and the dielectric layers 14, and to reduce or prevent an occurrence of defects in the internal structure of the multilayer body 12.

A curvature amount d of the L end portion of each outermost inner electrode 16 is preferably, for example, greater than or equal to about 1.5 μm and less than or equal to about 4.0 μm. Specifically, of the first inner electrodes 16a or the second inner electrodes 16b, the inner electrode 16 that is closest to the first surface 12a is configured such that the curvature amount of the L end portion on the side that is not connected to the first outer electrode 30a or the second outer electrode 30b is preferably, for example, greater than or equal to about 1.5 μm and less than or equal to about 4.0 μm. Of the first inner electrodes 16a or the second inner electrodes 16b, the inner electrode 16 that is closest to the second surface 12b is configured such that the curvature amount of the L end portion on the side that is not connected to the first outer electrode 30a or the second outer electrode 30b is preferably, for example, greater than or equal to about 1.5 μm and less than or equal to about 4.0 μm.

When only the L end portions of the outermost inner electrodes 16 are curved inward in the stacking direction x, it is possible to reduce stray capacitance that is generated between these inner electrodes 16 and the wraparound electrodes of the outer electrodes 30, and to reduce or prevent deviations or variations in electrostatic capacitance. On the other hand, since, when the curvature amount is too large, high temperature operating life may be reduced, the curvature amount is preferably, for example, greater than or equal to about 1.5 μm and less than or equal to about 4.0 μm.

The curvature amount can be measured as follows.

For example, the curvature amount of the L end portion 28a being arranged on the side that is not connected to the first outer electrode 30a or the second outer electrode 30b and being positioned at, of the first inner electrodes 16a or the second inner electrodes 16b, the inner electrode 16 that is closest to the first surface 12a can be measured as follows. That is, in a cross section along the stacking direction x and the first direction y (LT cross section) at approximately a ½W position in the second direction z, when a surface of the outermost inner electrode 16, the surface being arranged on a side of the second surface 12b and toward the center of the multilayer body 12, is a reference surface S1, the distance between the L end portion 28a of the outermost inner electrode 16 and the reference surface S1 can be measured as the curvature amount d. The curvature amount of the L end portion 28b being arranged on a side that is not connected to the first outer electrode 30a or the second outer electrode 30b and being positioned at, of the first inner electrodes 16a or the second inner electrodes 16b, the inner electrode 16 that is closest to the second surface 12b can be measured by the same measuring method.

It is preferable that the L end portions of the outermost inner electrodes 16 is curved inward in the stacking direction x, and that L end portions of the auxiliary electrodes 25 is not curved. Specifically, L end portions 28c of the second auxiliary electrodes 25b on a side that is not connected to the second outer electrode 30b are preferably not curved. L end portions 28d of the first auxiliary electrodes 25a on a side that is not connected to the first outer electrode 30a are preferably not curved.

In this way, when only the L end portions of the outermost inner electrodes 16 are curved inward in the stacking direction x, it is possible to reduce stray capacitance that is generated between these inner electrodes 16 and the wraparound electrodes of the outer electrodes 30, and to reduce or prevent deviations or variations in electrostatic capacitance. In addition, it is possible to increase adhesion strength between the inner electrodes 16 and the dielectric layers 14, and to reduce or prevent an occurrence of defects in the internal structure of the multilayer body 12. Further, when the first auxiliary electrodes 25a and the second auxiliary electrodes 25b are provided, it is possible to reduce differences in levels at the L gaps.

On the other hand, the L end portions of the outermost inner electrodes 16 may be curved inward in the stacking direction x and the L end portions of outermost auxiliary electrodes 25 may also be curved inward in the stacking direction x. Specifically, of the first auxiliary electrodes 25a or the second auxiliary electrodes 25b, the auxiliary electrode 25 that is closest to the first surface may be, at the L end portion 28c on the side that is not connected to the first outer electrode 30a or the second outer electrode 30b, curved toward the second surface 12b. Of the first auxiliary electrodes 25a and the second auxiliary electrodes 25b, the auxiliary electrode 25 that is closest to the second surface 12b may be, at the L end portion 28d on the side that is not connected to the first outer electrode 30a or the second outer electrode 30b, curved toward the first surface 12a.

In this way, when only the L end portions of the outermost inner electrodes 16 are curved inward in the stacking direction x, it is possible to reduce stray capacitance that is generated between these inner electrodes 16 and the wraparound electrodes of the outer electrodes 30, and to reduce or prevent deviations or variations in electrostatic capacitance. In addition, it is possible to increase adhesion strength between the inner electrodes 16 and the dielectric layers 14, and to reduce or prevent an occurrence of defects in the internal structure of the multilayer body 12.

Further, when the L end portions of the first auxiliary electrodes 25a and the L end portions of the second auxiliary electrodes 25b are also each curved inward in the stacking direction x, it is possible to increase adhesion strength between the inner electrodes 16 and the dielectric layers 14.

As shown in FIG. 3, a distance t₁ between the L end portion of the curved portion of an outermost inner electrode 16 and a main surface is preferably larger than a distance t₂ between the outermost inner electrode 16 and the main surface. Specifically, the distance t₁ between the first surface 12a and the L end portion 28a of the curved portion 29a of, of the first inner electrodes 16a or the second inner electrodes 16b, the inner electrode 16 that is closest to the first surface 12a is preferably larger than the distance t₂ between the first surface 12a and a surface S2 of, of the first inner electrodes 16a or the second inner electrodes 16b, the inner electrode 16 that is closest to the first surface 12a, the surface S2 being located on a side of the first surface 12a. The distance between the second surface 12b and the L end portion 28b of the curved portion 29b of, of the first inner electrodes 16a or the second inner electrodes 16b, the inner electrode 16 that is closest to the second surface 12b is preferably larger than the distance between the second surface 12b and a surface of, of the first inner electrodes 16a or the second inner electrodes 16b, the inner electrode 16 that is closest to the second surface 12b, the surface being located on a side of the second surface 12b.

In this way, when only the L end portions of the outermost inner electrodes 16 are curved inward in the stacking direction x, it is possible to reduce stray capacitance that is generated between these inner electrodes 16 and the wraparound electrodes of the outer electrodes 30, and to reduce or prevent deviations or variations in electrostatic capacitance. In addition, it is possible to increase adhesion strength between the inner electrodes 16 and the dielectric layers 14, and to reduce or prevent an occurrence of defects in the internal structure of the multilayer body 12.

The first-surface-side outer layer portion 20a is positioned on a side of the first surface 12a of the multilayer body 12, and is an assembly of a plurality of outer layer dielectric layers 14b, which are a plurality of dielectric layers 14 that are positioned between the first surface 12a and the inner electrode 16 that is closest to the first surface 12a.

The second-surface-side outer layer portion 20b is positioned on a side of the second surface 12b of the multilayer body 12, and is an assembly of a plurality of outer layer dielectric layers 14b, which are a plurality of dielectric layers 14 that are positioned between the second surface 12b and the inner electrode 16 that is closest to the second surface 12b.

A region between the first-surface-side outer layer portion 20a and the second-surface-side outer layer portion 20b is the inner layer portion 18.

The first-surface-side outer layer portion 20a and the second-surface-side outer layer portion 20b are each made of an insulating material. When the first-surface-side outer layer portion 20a and the second-surface-side outer layer portion 20b are made of, for example, a dielectric material that is of the same type as the dielectric material of which each inner-layer dielectric layer 14a is made, the outer layer portions 20a and 20b may each include a plurality of outer-layer dielectric layers 14b or a single outer-layer dielectric layer 14b.

As shown in FIG. 1, the outer electrodes 30 are disposed on a side of a corresponding one of the third surface 12c and the fourth surface 12d of the multilayer body 12.

Each outer electrode 30 includes the underlying electrode layer 32 that includes a metal component and glass, and a plating layer 34 that is disposed on a surface of the underlying electrode layer 32.

The outer electrodes 30 include the first outer electrode 30a and the second outer electrode 30b.

The first outer electrode 30a is connected to the first inner electrodes 16a and is disposed on at least the third surface 12c. It is preferable that the first outer electrode 30a extends from the third surface 12c of the multilayer body 12 and is also provided on a portion of the first surface 12a and a portion of the second surface 12b and on a portion of the fifth surface 12e and a portion of the sixth surface 12f. The first outer electrode 30a is electrically connected to the first extended electrode portion 24a of each first inner electrode 16a.

The second outer electrode 30b is connected to the second inner electrodes 16b and is disposed on at least the fourth surface 12d. It is preferable that the second outer electrode 30b extends from the fourth surface 12d of the multilayer body 12 and is also provided on a portion of the first surface 12a and a portion of the second surface 12b and on a portion of the fifth surface 12e and a portion of the sixth surface 12f. The second outer electrode 30b is electrically connected to the second extended electrode portion 24b of each second inner electrode 16b.

In the multilayer body 12, when the first facing electrode portion 22a of each first inner electrode 16a and the second facing electrode portion 22b of each second inner electrode 16b face each other with a corresponding one of the dielectric layers 14 interposed therebetween, electrostatic capacitance is generated. Therefore, electrostatic capacitance can be provided between the first outer electrode 30a to which the first inner electrodes 16a are connected and the second outer electrode 30b to which the second inner electrodes 16b are connected, and capacitor characteristics are provided.

The underlying electrode layers 32 include a first underlying electrode layer 32a and a second underlying electrode layer 32b.

The first underlying electrode layer 32a is connected to the first inner electrodes 16a and is disposed on the third surface 12c. It is preferable that the first underlying electrode layer 32a extends from the third surface 12c and is also provided on a portion of the first surface 12a and a portion of the second surface 12b and on a portion of the fifth surface 12e and a portion of the sixth surface 12f. The first underlying electrode layer 32a is electrically connected to the first extended electrode portion 24a of each first inner electrode 16a.

The second underlying electrode layer 32b is connected to the second inner electrodes 16b and is disposed on of the fourth surface 12d. It is preferable that the second underlying electrode layer 32b extends from the fourth surface 12d and is also provided on a portion of the first surface 12a and a portion of the second surface 12b and on a portion of the fifth surface 12e and a portion of the sixth surface 12f. The second underlying electrode layer 32b is electrically connected to the second extended electrode portion 24b of each second inner electrode 16b.

The underlying electrode layers 32 include, for example, Cu as a main component. The underlying electrode layers 32 include a glass component in addition to Cu as a main component. When each underlying electrode layer 32 includes Cu having a low specific electrical resistance as a main component, it is possible to reduce the ESR of the multilayer ceramic capacitor 10. When each underlying electrode layer 32 includes a glass component, it is possible to increase the sinterability of each underlying electrode layer 32. Examples of the glass component can include B, Si, Ba, Mg, Al, or Li.

The thickness in the first direction y connecting the third surface 12c and the fourth surface 12d at a central portion in the stacking direction x of the first underlying electrode layer 32a that is positioned on the third surface 12c is preferably, for example, greater than or equal to about 5 μm and less than or equal to about 50 μm.

The thickness in the first direction y connecting the third surface 12c and the fourth surface 12d at a central portion in the stacking direction x of the second underlying electrode layer 32b that is positioned on the fourth surface 12d is preferably, for example, greater than or equal to about 5 μm and less than or equal to about 50 μm.

Next, a first plating layer 34a and a second plating layer 34b, which are the plating layers 34 that are disposed on the underlying electrode layers 32, are described with reference to FIGS. 2 and 3.

The first plating layer 34a and the second plating layer 34b include, for example, at least one of Cu, Ni, Sn, Ag, Pd, an Ag—Pd alloy, or Au.

The first plating layer 34a is provided to cover the first underlying electrode layer 32a.

The second plating layer 34b is provided to cover the second underlying electrode layer 32b.

The first plating layer 34a and the second plating layer 34b may include a plurality of layers. In this case, the plating layers 34 each preferably have a two-layer structure including a lower-layer plating layer (Ni plating layer) that is provided on the underlying electrode layer 32 by Ni plating, and an upper-layer plating layer (Sn plating layer) that is provided on the lower-layer plating layer by Sn plating.

That is, in this case, the first plating layer 34a includes a first lower-layer plating layer 36a and a first upper-layer plating layer 38a that is positioned on a surface of the first lower-layer plating layer 36a.

The second plating layer 34b includes a second lower-layer plating layer 36b and a second upper-layer plating layer 38b that is positioned on a surface of the second lower-layer plating layer 36b.

The lower-layer plating layers 36 formed by the Ni plating are used to prevent corrosion of the underlying electrode layers 32 caused by solder used when the multilayer ceramic capacitor 10 is being mounted, and the upper-layer plating layers 38 formed by the Sn plating are used to increase wettability of the solder used when the multilayer ceramic capacitor 10 is being mounted and to thus make it possible to facilitate the mounting.

The thickness of each one of the lower-layer plating layers 36 and the thickness of each one of the upper-layer plating layers 38 are preferably, for example, greater than or equal to about 0.5 μm and less than or equal to about 10.0 μm.

A dimension in the first direction y of the multilayer ceramic capacitor 10 including the multilayer body 12, the first outer electrode 30a, and the second outer electrode 30b is an L dimension, a dimension in the stacking direction x of the multilayer ceramic capacitor 10 including the multilayer body 12, the first outer electrode 30a, and the second outer electrode 30b is a T dimension, and a dimension in the second direction z of the multilayer ceramic capacitor 10 including the multilayer body 12, the first outer electrode 30a, and the second outer electrode 30b is a W dimension.

Although the dimensions of the multilayer ceramic capacitor 10 are, for example, such that the L dimension in the first direction y is greater than or equal to about 0.10 mm and less than or equal to about 0.40 mm, the W dimension in the second direction z is greater than or equal to about 0.30 mm and less than or equal to about 0.70 mm, and the T dimension in the stacking direction x is greater than or equal to about 0.05 mm and less than or equal to about 0.25 mm, the dimensions are not limited thereto.

When the multilayer ceramic capacitor 10 has the sizes described above, it is possible to reduce mounting space.

The L dimension in the first direction y of the multilayer ceramic capacitor 10 may be, for example, greater than or equal to about 0.40 mm and less than or equal to about 0.60 mm, its W dimension in the second direction z may be, for example, greater than or equal to about 0.70 mm and less than or equal to about 1.10 mm, and its T dimension in the stacking direction x may be, for example, greater than or equal to about 0.25 mm and less than or equal to about 0.90 mm.

When the multilayer ceramic capacitor 10 has the sizes described above, it is possible to increase electrostatic capacitance in accordance with a matching frequency.

The dimensions of the multilayer ceramic capacitor 10 can be measured with a microscope, for example.

In the multilayer ceramic capacitor 10 shown in FIG. 1, of the first inner electrodes 16a or the second inner electrodes 16b, the inner electrode 16 that is closest to the first surface 12a is, at the L end portion 28a on the side that is not connected to the first outer electrode 30a or the second outer electrode 30b, curved toward the second surface 12b, and, of the first inner electrodes 16a or the second inner electrodes 16b, the inner electrode 16 that is closest to the second surface is, at the L end portion 28b on the side that is not connected to the first outer electrode 30a or the second outer electrode 30b, curved toward the first surface 12a. Therefore, since the L end portions of the outermost inner electrodes 16 are curved inward in the stacking direction x, it is possible to reduce stray capacitance that is generated between these inner electrodes 16 and the wraparound electrodes of the outer electrodes 30, and to reduce or prevent deviations or variations in electrostatic capacitance. In addition, it is possible to increase adhesion strength between the inner electrodes 16 and the dielectric layers 14, and to reduce or prevent an occurrence of defects in the internal structure of the multilayer body 12.

Next, an example of a method of producing the multilayer ceramic capacitor according to the present example embodiment is described.

First, ceramic green sheets for dielectric layers and conductive pastes for inner electrodes are prepared. The ceramic green sheets and the conductive pastes for the inner electrodes include binders and organic solvents. The binders and the organic solvents may be those that are publicly known.

Here, the ceramic green sheets for the inner-layer dielectric layers 14 include, as a main component, a ceramic material including, as a main component, at least one of Ca, Sr, Zr, or Ti, for example. Specifically, for example, a ceramic material having a perovskite structure represented by a general formula ABO₃ including Ca and Zr is a main component. Examples of such a ceramic material having a perovskite structure include CaZrO₃ (calcium zirconate) and TiO₂ (titanium oxide), but are not limited thereto. Main components of the ceramic material of which each dielectric layer 14 is made may include Ca, Zr, or Ti. For CaZrO₃, for example, Ca(Zr_{0.9}Ti_{0.1})O₃ in which a portion of ZrO₃ or a portion of Zr is substituted by Ti may be used.

Then, the conductive pastes for the inner electrodes are printed with, for example, a predetermined pattern onto the ceramic green sheets for inner-layer dielectric-layer regions by, for example, screen printing or gravure printing. This causes the ceramic green sheets on which first inner electrode patterns are formed and ceramic green sheets on which second inner electrode patterns are formed to be prepared.

First, the ceramic green sheets on which are printed the first inner electrode patterns excluding the pattern of the outermost inner electrode on the side of the first surface 12a and the ceramic green sheets on which the second inner electrode patterns are printed are successively stacked on each other. Then, the ceramic green sheet that becomes the outermost inner electrode on the side of the first surface 12a is placed on a surface of a temporary multilayer block formed by the successive placements. Here, the placement pressure of a portion that becomes the outermost inner electrode on the side of the first surface 12a is set to be higher than the placement pressures of the other portions to perform the placement. Next, the temporary multilayer block on which the ceramic green sheet that becomes the outermost inner electrode on the side of the first surface 12a has been provided is inverted. Then, a ceramic green sheet that becomes the outermost inner electrode on the side of the second surface 12b of the temporary multilayer block that has been inverted is placed. Here, the placement pressure of a portion that becomes the outermost inner electrode on the side of the second surface 12b is set to be higher than the placement pressures of the other portions to perform the placement. This causes a portion that becomes the inner layer portion 18 to be formed.

Next, by providing a predetermined number of dielectric sheets on which the inner electrode layer patterns are not printed and placing these dielectric sheets on each other, a portion that becomes the second-surface-side outer layer portion 20b on the side of the second surface 12b is formed. Then, the portion that becomes the inner layer portion 18 formed by the above-described step is placed on the portion that becomes the second-surface-side outer layer portion 20b. Next, by providing a predetermined number of dielectric sheets on which the inner electrode layer patterns are not printed and placing these dielectric sheets on the portion that becomes the inner layer portion 18 formed by the above-described step, a portion that becomes the first-surface-side outer layer portion 20a on the side of the first surface 12a is formed. This causes a multilayer sheet to be formed.

Next, by pressing the multilayer sheet in the stacking direction with, for example, an isostatic press, a multilayer block is formed.

Then, by cutting the multilayer block into a predetermined size, a multilayer chip is cut out from the multilayer block.

Next, by firing the multilayer chip that has been cut out from the multilayer block, the multilayer body 12 is formed. Although depending upon the materials of the dielectric layers 14 and the materials of the inner electrodes 16, the firing temperature is preferably, for example, greater than or equal to about 900° C. and less than or equal to about 1400° C.

Next, conductive pastes for the underlying electrode layers including a metal component and glass component are prepared.

In the description below, the underlying electrode layers are formed by using baking layers. When forming the baking layers, conductive pastes including a glass component and a metal are prepared and are applied, and then a baking operation is performed to form the underlying electrode layers.

The first underlying electrode layer 32a of the first outer electrode 30a and the second underlying electrode layer 32b of the second outer electrode 30b are formed, respectively, on the third surface 12c and the fourth surface 12d of the multilayer body 12 obtained by the firing.

When the baking layers are to be formed as the underlying electrode layers 32, the conductive pastes including a glass component and a metal component are applied by, for example, a method such as dipping, and then the baking operation is performed to form the baking layers as the underlying electrode layers 32. The baking temperature at this time is preferably, for example, greater than or equal to about 700° C. and less than or equal to about 900° C. In the present example embodiment, the underlying electrode layers 32 are formed by using baking layers.

When the underlying electrode layers 32 are to be formed by using baking layers, the baking layers may include a ceramic component. In this case, the backing layers may include the ceramic component instead of the glass component or may include both.

Next, as required, the surfaces of the underlying electrode layers are plated to form plating layers. In the present example embodiment, two plating layers are formed on the surface of each underlying electrode layer. Specifically, for example, the Ni plating layer and the Sn plating layer are formed on each underlying electrode layer. As a plating operation, for example, electrolytic plating is preferably used. The Ni plating layer and the Sn plating layer are successively formed by, for example, a barrel plating method.

As described above, the multilayer ceramic capacitor 10 according to the present example embodiment is produced.

Next, in order to confirm the advantageous effects of the above-described multilayer ceramic capacitor according to the present example embodiment, in accordance with the above-described producing method, as samples of an experiment, samples whose L end portions of outermost inner electrodes are curved inward in the stacking direction x were formed and were checked for variations in electrostatic capacitance and defects in internal structures.

By using the producing method according to the above-described example embodiment, multilayer ceramic capacitors, which are samples of a comparative example and Examples 1 to 5 were formed.
Structure of each multilayer ceramic capacitors: multilayer ceramic capacitor shown in FIG. 1
Dimension of each multilayer ceramic capacitor in first direction: about 0.30 mm
Dimension of each multilayer ceramic capacitor in second direction: about 0.60 mm
Dimension of each multilayer ceramic capacitor in stacking direction: about 0.18 mm
Main component of inner electrodes: Cu
Main component of inner-layer dielectric layers: CaZrO₃
Thickness of dielectric layers: about 15 μm
Thickness of inner electrodes: about 2 μm
Main component of underlying electrode layers: Cu
Number of first inner electrodes: 4
Number of second inner electrodes: 4
Thickness of first-surface-side outer layer portion: about 25 μm
Thickness of second-surface-side outer layer portion: about 25 μm
Dimension of L gaps: about 100 μm
Dimension of W gaps: about 60 μm

The samples of the examples were formed by the method of producing the multilayer ceramic capacitor according to the above-described embodiment. As the samples of Examples 1 to 5, samples whose L end portions of the outermost inner electrodes were curved inward in the stacking direction x were prepared. As the sample of the comparative example, a sample whose L end portions of the outermost inner electrodes were not curved inward in the stacking direction x was prepared.

In a cross section (LT cross section) along the stacking direction x and the first direction y at approximately a ½W position in the second direction z, when a surface of each outermost inner electrode toward the center of a multilayer body was a reference surface S1, the distance between the reference surface S1 and the L end portion of each outermost inner electrode was measured as a curvature amount d. As a measuring device, for example, a digital microscope (manufactured by Keyence Corporation, Model Number: VHX-8000) was used.

The method of measuring the electrostatic capacitance was performed to measure the electrostatic capacitance obtained under the conditions of, for example, a measurement frequency of about 1 MHz and a measurement voltage of about 1.0 Vrms by using a measuring device (manufactured by Keysight Technologies Inc, Model Number: E4981A) and by using a measuring jig (manufactured by Keysight Technologies Inc, Model Number: 16034H). The number of samples was 30. In order to evaluate the amount of variation in the electrostatic capacitance measured for each sample, a standard deviation of the electrostatic capacitance was determined, a value divided by the average value of the electrostatic capacitance was calculated as a CV value, and this was used for the evaluation.

In the cross section (LT cross section) along the stacking direction x and the first direction y at approximately the ½W position in the second direction z of each multilayer ceramic capacitor or each sample, the number of multilayer ceramic capacitors where there was cracking or peeling between the dielectric layers and the inner electrodes closest to a corresponding one of surfaces of the multilayer body was counted. The number of samples was 10000.

Table 1 indicates, for the multilayer ceramic capacitors or the samples according to the comparative example and Examples 1 to 5, the results of the CV values of the electrostatic capacities when the curvature amounts were changed, the results of the numbers of occurrences of internal structure defects when the curvature amounts were changed, and the results of overall evaluations.

When the CV value was greater than about 6% and internal structure defects occurred, the evaluation was determined as being “poor”, when the CV value was greater than about 5% and less than or equal to about 6% and internal structure defects did not occur, the evaluation was determined as being “fair”, and when the CV value was less than or equal to about 5% and internal structure defects did not occur, the evaluation was determined as being “good”.

TABLE 1

| | | Electrostatic | Number of | |
|---|---|---|---|---|
| | | Capacitance | Occurrences | |
| | Curvature | Variations | of Internal | |
| | Amount | (CV value) | Structure Defects | Overall |
| | (μm) | (%) | (Number) | Evaluation |
| Comparative | — | 7.4 | 2/10000 | Poor |
| Example | | | | |
| Example 1 | 1.1 | 5.2 | 0/10000 | Fair |
| Example 2 | 1.5 | 3.3 | 0/10000 | Good |
| Example 3 | 1.9 | 3.1 | 0/10000 | Good |
| Example 4 | 3.2 | 2.2 | 0/10000 | Good |
| Example 5 | 4.0 | 2.0 | 0/10000 | Good |

According to Table 1, focusing on the CV values of the electrostatic capacitances, in Examples 1 to 5, curved portions that are curved inward in the stacking direction x are formed at the L end portions of the outermost inner electrodes, and, in Examples 1 to 5, as the curvature amounts increase, the values of the CV values of the electrostatic capacities decrease.

Therefore, it was confirmed that, as the curvature amount increased, the samples obtained were multilayer ceramic capacitors having an electrostatic capacitance conforming to a design value.

In contrast, in the sample of the comparative example, since a curved portion that curves inward in the stacking direction x is not formed at the L end portion of each outermost inner electrode, it was confirmed that the CV value of the electrostatic capacitance was a CV value greater than the CV values of Examples 1 to 5.

Focusing on the numbers of occurrences of defects in the internal structures of the multilayer bodies, for the samples of Examples 1 to 5, the numbers of occurrences of defects in the internal structures of the multilayer bodies were 0.

In contrast, in the sample of the comparative example, since a curved portion that is curved inward in the stacking direction x is not formed at the L end portion of each outermost inner electrode, defects were found in two samples out of 10000 samples.

The results above confirmed that when the L end portions of the outermost inner electrodes were curved inward in the stacking direction x, stray capacitance occurring between the inner electrodes and wraparound electrodes of outer electrodes can be reduced and that deviations or variations from the design electrostatic capacities of the multilayer ceramic capacitors can be reduced or prevented. The results above also confirmed that since the adhesion strengths between the inner electrodes and the dielectric layers increased, defects in the internal structures of inner portions of the multilayer bodies can be reduced or prevented.

Although example embodiments of the present invention have been described above, the present invention is not limited thereto.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of dielectric layers stacked on each other, a plurality of inner electrodes on the plurality of dielectric layers, a first surface and a second surface facing each other in a stacking direction, a third surface and a fourth surface facing each other in a first direction orthogonal or substantially orthogonal to the stacking direction, and a fifth surface and a sixth surface facing each other in a second direction orthogonal or substantially orthogonal to the stacking direction and the first direction;
a first outer electrode on the third surface of the multilayer body; and
a second outer electrode on the fourth surface of the multilayer body; wherein
when a dimension of the multilayer body in the first direction is 1 and a dimension of the multilayer body in the second direction is w, w>1;
the plurality of inner electrodes include:
first inner electrodes on the plurality of dielectric layers, exposed at the third surface, and connected to the first outer electrode; and
second inner electrodes on the plurality of dielectric layers, exposed at the fourth surface, and connected to the second outer electrode;
the plurality of inner electrodes include, as a main component, Cu;
the plurality of dielectric layers include, as a main component, a dielectric material including at least one of Ca, Sr, Zr, or Ti;
of the first inner electrodes or the second inner electrodes, the inner electrode closest to the first surface is, at an end portion on a side that is not connected to the first outer electrode or the second outer electrode, curved toward the second surface; and
of the first inner electrodes or the second inner electrodes, the inner electrode closest to the second surface is, at an end portion on a side that is not connected to the first outer electrode or the second outer electrode, curved toward the first surface.

2. The multilayer ceramic capacitor according to claim 1, wherein
of the first inner electrodes or the second inner electrodes, at only the end portion on the side that is not connected to the first outer electrode or the second outer electrode, the inner electrode closest to the first surface is curved toward the second surface and includes a curved portion; and
of the first inner electrodes or the second inner electrodes, at only the end portion on the side that is not connected to the first outer electrode or the second outer electrode, the inner electrode closest to the second surface is curved toward the first surface and includes a curved portion.

3. The multilayer ceramic capacitor according to claim 1, wherein
of the first inner electrodes or the second inner electrodes, the inner electrode closest to the first surface is configured such that a curvature amount of the end portion on the side that is not connected to the first outer electrode or the second outer electrode is greater than or equal to about 1.5 μm and less than or equal to about 4.0 μm; and
of the first inner electrodes or the second inner electrodes, the inner electrode closest to the second surface is configured such that a curvature amount of the end portion on the side that is not connected to the first outer electrode or the second outer electrode is greater than or equal to about 1.5 μm and less than or equal to about 4.0 μm.

4. The multilayer ceramic capacitor according to claim 1, further comprising:
first auxiliary electrodes in a same plane as the first inner electrodes and connected to the second outer electrode; and
second auxiliary electrodes in a same plane as the second inner electrodes and connected to the first outer electrode; wherein
an end portion of each of the first auxiliary electrodes on a side that is not connected to the second outer electrode is not curved; and
an end portion of each of the second auxiliary electrodes on a side that is not connected to the first outer electrode is not curved.

5. The multilayer ceramic capacitor according to claim 1, further comprising:
first auxiliary electrodes in a same plane as the first inner electrodes and connected to the second outer electrode; and
second auxiliary electrodes in a same plane as the second inner electrodes and connected to the first outer electrode; wherein
of the first auxiliary electrodes or the second auxiliary electrodes, the auxiliary electrode closest to the first surface is, at an end portion on a side that is not connected to the first outer electrode or the second outer electrode, curved toward the second surface; and
of the first auxiliary electrodes or the second auxiliary electrodes, the auxiliary electrode closest to the second surface is, at an end portion on a side that is not connected to the first outer electrode or the second outer electrode, curved toward the first surface.

6. The multilayer ceramic capacitor according to claim 1, wherein
a distance between the first surface and an end of a curved portion of, of the first inner electrodes or the second inner electrodes, the inner electrode closest to the first surface is larger than a distance between the first surface and, of the first inner electrodes or the second inner electrodes, the inner electrode that is closest to the first surface; and
a distance between the second surface and an end of a curved portion of, of the first inner electrodes or the second inner electrodes, the inner electrode closest to the second surface is larger than a distance between the second surface and, of the first inner electrodes or the second inner electrodes, the inner electrode that is closest to the second surface.

7. The multilayer ceramic capacitor according to claim 1, wherein
a dimension L of the multilayer ceramic capacitor in the first direction is greater than or equal to about 0.10 mm and less than or equal to about 0.40 mm;
a dimension W of the multilayer ceramic capacitor in the second direction is greater than or equal to about 0.30 mm and less than or equal to about 0.70 mm; and
a dimension T of the multilayer ceramic capacitor in the stacking direction is greater than or equal to about 0.05 mm and less than or equal to about 0.25 mm.

8. The multilayer ceramic capacitor according to claim 1, wherein
a dimension L of the multilayer ceramic capacitor in the first direction is greater than or equal to about 0.40 mm and less than or equal to about 0.60 mm;
wherein a dimension W of the multilayer ceramic capacitor in the second direction is greater than or equal to about 0.70 mm and less than or equal to about 1.10 mm; and
a dimension T of the multilayer ceramic capacitor in the stacking direction is greater than or equal to about 0.25 mm and less than or equal to about 0.90 mm.

9. The multilayer ceramic capacitor according to claim 1, wherein the multilayer body includes rounded portions at corners and ridges of the multilayer body.

10. The multilayer ceramic capacitor according to claim 1, wherein the dielectric material has a perovskite structure represented by a formula ABO₃ including Ca and Zr as main components.

11. The multilayer ceramic capacitor according to claim 1, wherein the dielectric material includes Mn, Mg, Dy, or Cr, or oxides of rare-earth elements such as V, Sm, Eu, Gd, Tb, Ho, Er, Tm, Yb, or Y, or oxides of Co, Ni, Li, B, Na, K, or Si, or glass as an additive.

12. The multilayer ceramic capacitor according to claim 1, wherein a thickness of each of the plurality of dielectric layers is greater than or equal to about 1 μm and less than or equal to about 100 μm.

13. The multilayer ceramic capacitor according to claim 1, wherein a thickness of each of the plurality of inner electrodes is greater than or equal to about 0.5 μm and less than or equal to about 3.0 μm.

14. The multilayer ceramic capacitor according to claim 1, wherein a thickness of each of the plurality of inner electrodes is greater than or equal to about 1.2 μm and less than or equal to about 2.4 μm.

15. The multilayer ceramic capacitor according to claim 1, wherein each of the first and second outer electrodes includes an underlying electrode layer including a metal component and a glass component, and a plating layer on the underlying electrode layer.

16. The multilayer ceramic capacitor according to claim 15, wherein each of the first and second underlying electrode layers includes Cu as a main component.

17. The multilayer ceramic capacitor according to claim 15, wherein the glass component includes B, Si, Ba, Mg, Al, or Li.

18. The multilayer ceramic capacitor according to claim 15, wherein a maximum thickness of each of the first and second underlying electrode layers is about 5 μm and less than or equal to about 50 μm.

19. The multilayer ceramic capacitor according to claim 15, wherein the plating layer includes at least one of Cu, Ni, Sn, Ag, Pd, an Ag—Pd alloy, or Au.

20. The multilayer ceramic capacitor according to claim 15, wherein the plating layer includes a Ni plating layer on the underlying electrode layer and an Sn plating layer on the Ni plating layer.
